(19) United States
(12) Patent Application Publication
(10) Pub. No.: US 2022/0382273 A1
(43) Pub. Date: Dec. 1, 2022

(54) DATA COLLECTION SYSTEM AND RECORDING MEDIUM

(71) Applicant: SUMITOMO HEAVY INDUSTRIES, LTD., Tokyo (JP)

(72) Inventor: Shunsuke OTSUKI, Kanagawa (JP)

(21) Appl. No.: 17/818,486

(22) Filed: Aug. 9, 2022

Related U.S. Application Data
(63) Continuation of application No. PCT/JP2021/005192, filed on Feb. 12, 2021.

(30) Foreign Application Priority Data
Feb. 14, 2020 (JP) 2020-023838

(51) Int. Cl. G05B 23/02

(52) U.S. Cl. CPC G05B 23/0283

(57) ABSTRACT

A data collection system includes an input device configured to receive an input from a user, a first hardware processor configured to obtain data related to a work machine with a work attachment and satisfying a predetermined condition, according to the input received by the input device, and a second hardware processor configured to execute a process related to providing the user with an incentive when the first hardware processor obtains the data.

### CROSS-REFERENCE TO RELATED APPLICATIONS

This application is a continuation application filed under 35 U.S.C. 111(a) claiming benefit under 35 U.S.C. 120 and 365(c) of PCT International Application No. PCT/JP2021/005192, filed on Feb. 12, 2021 and designating the U.S., which claims priority to Japanese Patent Application No. 2020-023838, filed on Feb. 14, 2020. The entire contents of the foregoing applications are incorporated herein by reference.

### BACKGROUND

### Technical Field

The present disclosure relates to data collection systems, etc.

### Description of Related Art

Techniques for collecting various data on an industrial machine and performing various analyses, etc., have been known.

There is a technique for collecting various data on a shovel and analyzing (evaluating) the operating characteristics of an operator in light of work efficiency, energy saving, etc.

There is also a technique for collecting the operation data of a work machine and performing an analysis on failure prediction.

### SUMMARY

According to an aspect of the present disclosure, a data collection system includes an input device configured to receive an input from a user, a first hardware processor configured to obtain data related to a work machine with a work attachment and satisfying a predetermined condition, according to the input received by the input device, and a second hardware processor configured to execute a process related to providing the user with an incentive when the first hardware processor obtains the data.

### BRIEF DESCRIPTION OF THE DRAWINGS

FIG. 1 is a schematic diagram illustrating an example of a data collection system;

FIG. 2 is a schematic diagram illustrating another example of the data collection system;

FIG. 3 is a diagram illustrating an example of the overview of the operation of the data collection system;

FIG. 4 is a diagram illustrating another example of the overview of the operation of the data collection system;

FIG. 5 is a block diagram illustrating an example of the configuration of the data collection system;

FIG. 6 is a block diagram illustrating another example of the configuration of the data collection system;

FIG. 7 is a flowchart schematically illustrating a first example of a requested data obtaining process executed by a user apparatus (a controller);

FIG. 8 illustrates a first example of a request screen displayed on the user apparatus (an output device);

FIG. 9 is a diagram illustrating an example of requested data;

FIG. 10 is a flowchart schematically illustrating a second example of the requested data obtaining process executed by the user apparatus (the controller);

FIG. 11 illustrates a second example of the request screen displayed on the user apparatus (the output device);

FIG. 12 is a flowchart schematically illustrating a third example of the requested data obtaining process executed by the user apparatus (the controller);

FIG. 13 illustrates a third example of the request screen displayed on the user apparatus (the output device);

FIG. 14 is a flowchart schematically illustrating a fourth example of the requested data obtaining process executed by the user apparatus (the controller);

FIG. 15 illustrates a fourth example of the request screen displayed on the user apparatus (the output device);

FIG. 16 is a flowchart schematically illustrating a fifth example of the requested data obtaining process executed by the user apparatus (the controller);

FIG. 17 illustrates a fifth example of the request screen displayed on the user apparatus (the output device);

FIG. 18 is a block diagram illustrating yet another example of the configuration of the data collection system; and

FIG. 19 is a block diagram illustrating a hardware configuration of the user apparatus.

### DETAILED DESCRIPTION

The operating conditions of an industrial machine to which certain data correspond may not be determined from the data alone, for example. Furthermore, for example, in the case of performing machine learning (supervised learning) using collected data, ground truth data (labeled training data) corresponding to the collected data are necessary, and a desired analysis may not be conducted by simply collecting data. Furthermore, for example, a process for generating labeled training data is separately required, so that sufficient labeled training data may not be prepared in teams of time, labor, etc. Therefore, it is desirable that data with verified identity that satisfy a predetermined condition required in an analysis, such as data with metadata that satisfy a predetermined condition corresponding to the contents of an analysis and data that satisfy a predetermined condition corresponding to the contents of an analysis, be collected.

Therefore, there is a demand for a technique that makes it possible to collect data that satisfy a predetermined condition.

According to an embodiment, it is possible to collect data that satisfy a predetermined condition.

An embodiment is described below with reference to the drawings.

### [Overview of Data Collection System]

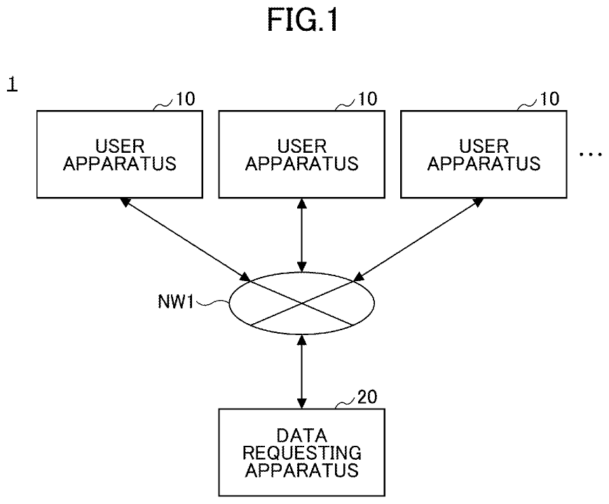

Examples of a data collection system 1 according to this embodiment are described with reference to FIGS. 1 through 4.

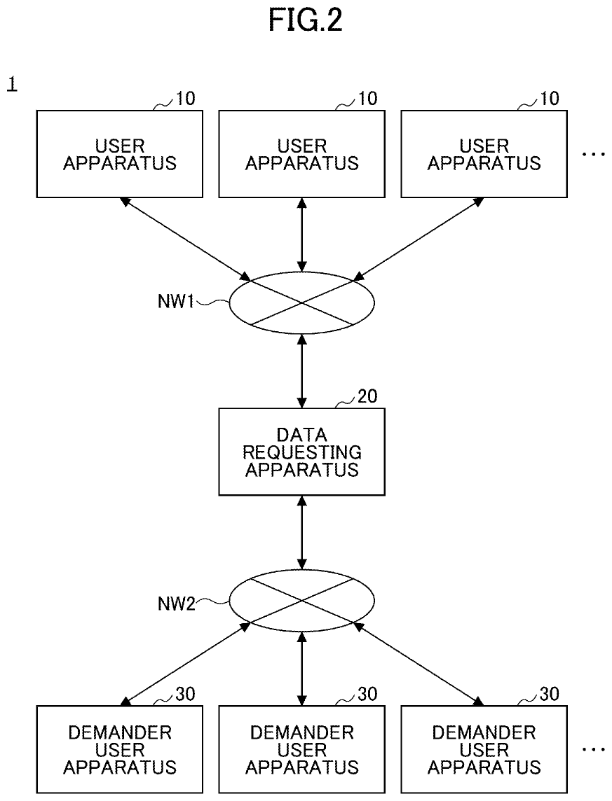

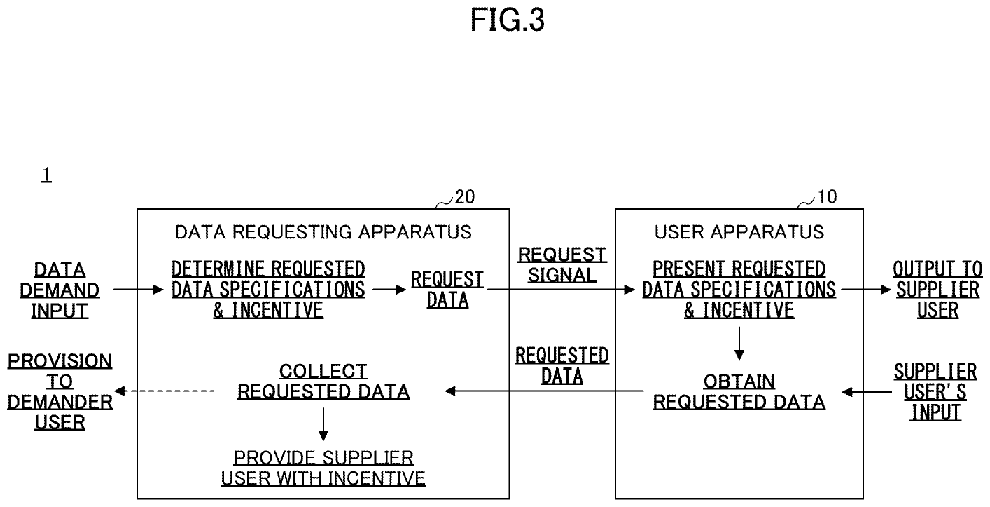

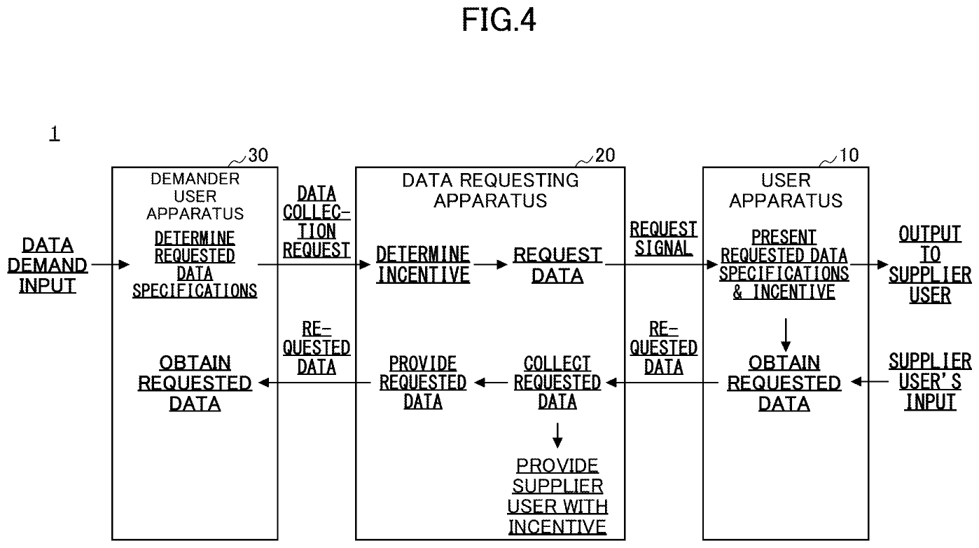

FIGS. 1 and 2 are schematic diagrams illustrating an example and another example of the data collection system 1 according to this embodiment. FIGS. 3 and 4 are diagrams illustrating an example and another example of an overview of the operation of the data collection system 1 according to this embodiment.

As illustrated in FIGS. 1 and 2, the data collection system 1 includes user apparatuses 10 and a data requesting apparatus 20 (an example of an information processing apparatus).

According to the data collection system 1, a user makes a predetermined input at each of the user apparatuses 10 in response to a request signal from the data requesting apparatus 20, so that data corresponding to the request signal (hereinafter “requested data”) are obtained (collected). The requested data are data that satisfy a predetermined condition. The requested data are described in detail below.

Each of the user apparatuses 10 is used by one of users who are suppliers of the requested data (hereinafter “supplier users”) in the data collection system 1. Each of the user apparatuses 10 may be tied to a particular supplier user or may be shared by two or more supplier users.

The user apparatuses 10 are, for example, user terminals. Examples of user terminals include portable terminals. Examples of portable terminals include cellular phones, smartphones, tablet terminals, and laptop computer terminals. Furthermore, examples of user terminals may include stationary terminals such as desktop computer terminals. Furthermore, the user apparatuses 10 may also be, for example, servers. Furthermore, the user apparatuses 10 may also be mechanical apparatuses (for example, industrial machines or the like) that are operated by supplier users to work. Examples of industrial machines include mobile industrial machines that can travel, such as shovels and bulldozers (so-called work machines). Work machines may include a work attachment. For example, in the case of shovels, a boom attached to an upper swing structure, an aim attached to the distal end of the boom, and a bucket that is an example of an end attachment attached to the distal end of the arm constitute an excavation attachment that is an example of a work attachment. Furthermore, examples of industrial machines include stationary industrial machines that are fixed at factories or the like, such as machine tools and injection molding machines.

Each of the user apparatuses 10 is communicably connected to the data requesting apparatus 20 through a communication line NW1. Examples of the communication line NW1 include wide area networks (WANs). Wide area networks may include mobile communication networks with a base station serving as an end. Furthermore, examples of wide area networks may also include satellite communications networks using a satellite. Furthermore, examples of wide area networks may also include the Internet. Furthermore, examples of the communication line NW1 may also include short-range communications networks based on communications standards such as WiFi and Bluetooth (registered trademarks). Furthermore, examples of the communication line NW1 may also include local area networks (LANs) and one-to-one communication lines. The same may apply to a communication line NW2 as described below. This enables the user apparatuses 10 to receive signals and data from the data requesting apparatus 20 and transmit signals and data to the data requesting apparatus 20.

The data requesting apparatus 20 transmits a request signal that requests the obtaining (generation) of the requested data to each of the user apparatuses 10 through the communication line NW1. The data requesting apparatus 20 collects (receives), from the user apparatuses 10, the requested data that are obtained at the user apparatuses 10 according to inputs from supplier users responding to the request.

The data requesting apparatus 20 is, for example, a cloud server installed at a location relatively remote from the user apparatuses 10. Furthermore, the data requesting apparatus 20 may also be, for example, an edge server installed at a location relatively close to some or all of the user apparatuses 10. In this case, there may be two or more data requesting apparatuses 20. Furthermore, the data requesting apparatus 20 may also be, for example, a portable terminal or a stationary terminal.

Furthermore, as illustrated in FIG. 2, the data collection system 1 may further include demander user apparatuses 30.

The demander user apparatuses 30 are used by users who are demanders of the requested data (hereinafter “demander users”) in the data collection system 1. The number of demander user apparatuses 30 included in the data collection system 1 may be one or more.

Examples of the demander user apparatuses 30 include terminal apparatuses. Examples of terminal apparatuses include portable terminals and stationary terminal apparatuses. Furthermore, examples of the demander user apparatuses 30 may also include servers.

The demander user apparatuses 30 are communicably connected to the data requesting apparatus 20 through the communication line NW2. This enables the demander user apparatuses 30 to transmit signals to the data requesting apparatus 20 and receive data from the data requesting apparatus 20.

For example, as illustrated in FIG. 3, the data requesting apparatus 20 determines the specifications of the requested data and the details of an incentive offered to a supplier user for provision of the requested data, according to a data demand input from a worker or the like. The data requesting apparatus 20 transmits a request signal for the requested data, including the specifications of the requested data and the details of an incentive offered to a supplier user for provision of the requested data, to the user apparatus 10.

In response to receiving the request signal, the user apparatus 10 presents the specifications of the requested data and the details of the incentive to the supplier user. Then, according to an input from the supplier user, the user apparatus 10 obtains the requested data and returns the requested data to the data requesting apparatus 20.

The data requesting apparatus 20 can collect the requested data by receiving the requested data returned from the user apparatuses 10. The data requesting apparatus 20 then provides each supplier user who has cooperated in obtaining the requested data with an incentive for provision of the requested data.

Furthermore, the requested data may be offered (sold) to the demander users. In this case, the requested data are transmitted to the demander user apparatuses 30 through the communication line NW2.

Furthermore, for example, as illustrated in FIG. 4, the demander user apparatus 30 determines the specifications of the requested data according to a data demand input from a demander user (in the case where the demander user is a company, its employee or the like). The demander user apparatus 30 then transmits a data collection request including the specifications of the requested data to the data requesting apparatus 20.

In response to receiving the data collection request, the data requesting apparatus 20 determines the details of an incentive from the specifications of the requested data. Then, the same as in the case of FIG. 3, the data requesting apparatus 20 transmits a request signal for the requested data, including the specifications of the requested data and the details of an incentive offered to a supplier user for provision of the requested data, to the user apparatus 10.

The same as in the case of FIG. 3, in response to receiving the request signal, the user apparatus 10 presents the specifications of the requested data and the details of the incentive to the supplier user. Then, according to an input from the supplier user, the user apparatus 10 obtains the requested data and returns the requested data to the data requesting apparatus 20.

The same as in the case of FIG. 3, the data requesting apparatus 20 can collect the requested data by receiving the requested data returned from the user apparatuses 10. Furthermore, the data requesting apparatus 20 provides each supplier user who has cooperated in obtaining the requested data with an incentive for provision of the requested data. The data requesting apparatus 20 then transmits (offers) the collected requested data to the demander user apparatus 30. This enables the demander user apparatus 30 to obtain the requested data according to the demander user's demand via the data requesting apparatus 20.

In this embodiment, configurations and operations of the user apparatuses 10 and the data requesting apparatus 20 in the data collection system 1 are mainly described below.

### Specific Examples of Data Collection System

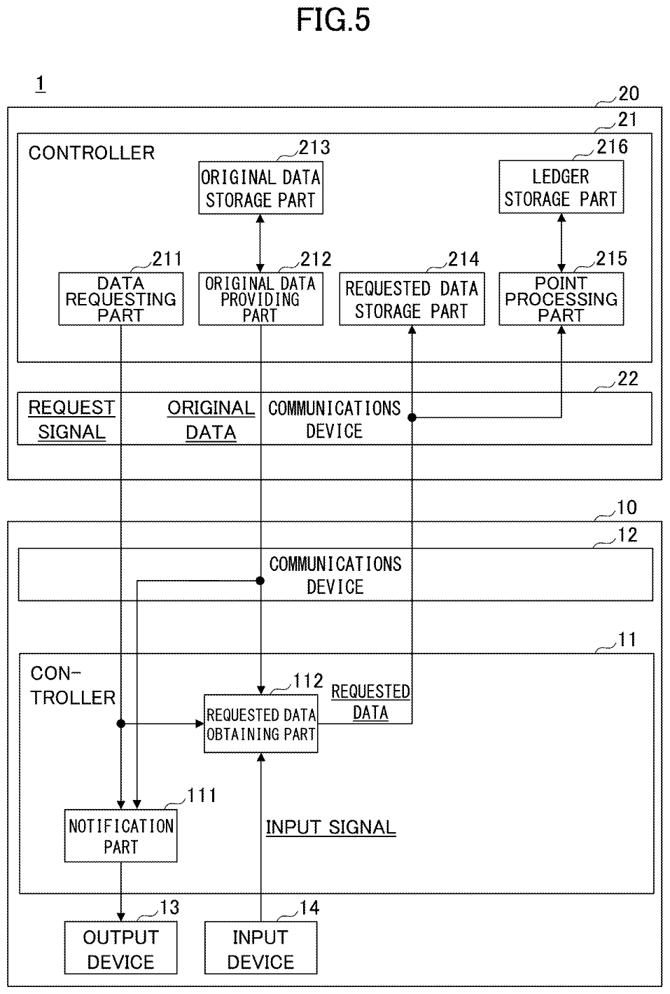

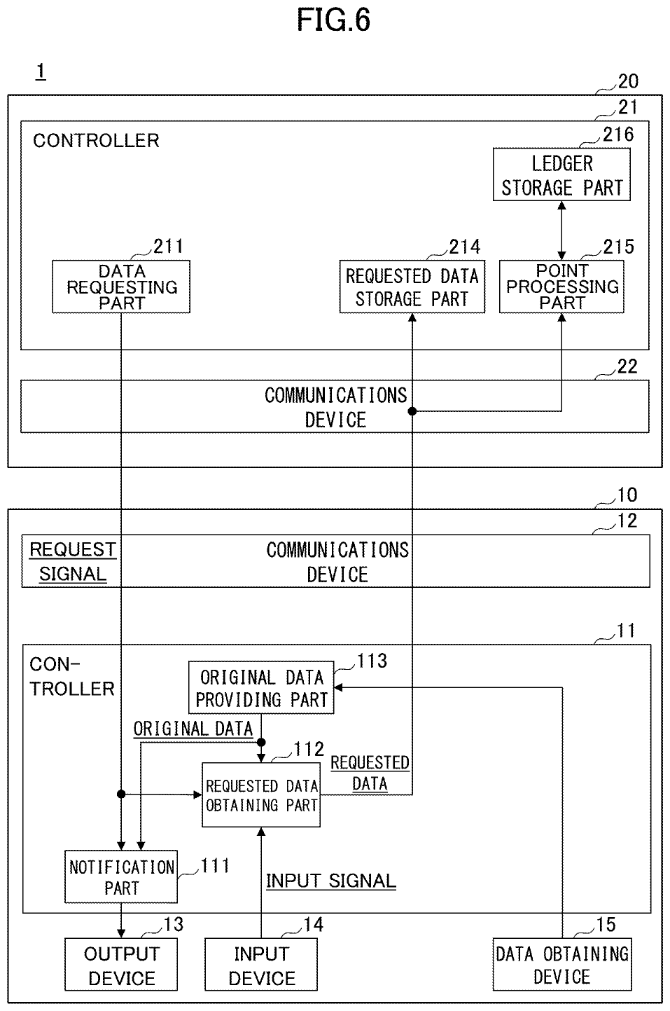

Next, specific examples of the configuration of the data collection system 1 are described with reference to FIGS. 5 and 6 in addition to FIGS. 1 through 4.

FIGS. 5 and 6 are block diagrams illustrating an example and another example, respectively, of the configuration of the data collection system 1.

### <Configuration of User Apparatus.

As illustrated in FIGS. 5 and 6, the user apparatus 10 includes a controller 11, a communications device 12, an output device 13, and an input device 14. Furthermore, as illustrated in FIG. 6, the user apparatus 10 may include a data obtaining device 15.

The controller 11 performs various kinds of control with respect to the user apparatus 10.

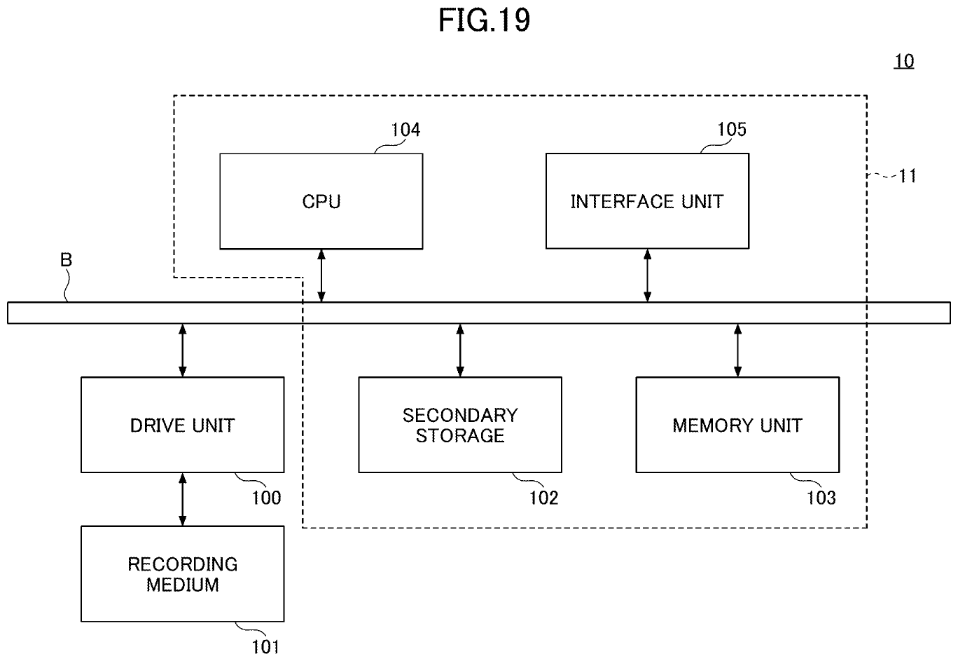

Functions of the controller 11 may be implemented by, for example, any hardware, a combination of any hardware and software, or the like. For example, as illustrated in FIG. 19, the controller 11 is composed mainly of a computer including a CPU (Central Processing Unit) 104, a memory unit 103 such as a RAM (Random Access memory), a nonvolatile secondary storage 102 such as a ROM (Read Only Memory), and an interface unit 105 for external input and output, which are interconnected by a bus B. In the following, the same may apply to a below-described controller 21 of the data requesting apparatus 20.

As illustrated in FIG. 5, the controller 11 includes a notification part 111 and a requested data obtaining part 112. Furthermore, as illustrated in FIG. 6, the controller 11 may also include an original data providing part 113. The functions of the notification part 111, the requested data obtaining part 112, and the original data providing part 113 are implemented by, for example, running a predetermined program installed in the secondary storage 102 on the CPU 104. The program may be recorded in a recording medium 101 and be installed in the secondary storage 102 via a drive unit 100 of the user apparatus 10. The program may also be downloaded via a communications network such as the communication line NW1 to be installed in the secondary storage 102.

The communications device 12 connects to the communication line NW1 to perform communications with the data requesting apparatus 20.

The output device 13 outputs various kinds of information with which the user apparatus 10 provides a supplier user. Examples of the output device 13 include a display device that outputs visual information (information images) and a lighting device (lamp). Examples of display devices include a liquid crystal display and an organic EL (Electroluminescence) display. The lighting device can impart information to a supplier user through the presence or absence of lighting, luminance, color, a flashing pattern, or the like. Furthermore, examples of the output device 13 include a sound output device that outputs auditory information (a predetermined sound, a voice, or the like). Examples of sound output devices include a buzzer and a loudspeaker

The input device 14 receives an input from a supplier user. Examples of the input device 14 include an operation input device that receives the input of a supplier user's operation. Examples of operation input devices may include a keyboard, a mouse, a button, a toggle, a touchscreen, and a touchpad. Furthermore, examples of the input device 14 may also include a voice input device that receives the input of a supplier user's voice and a gesture input device that receives the input of a supplier user's gesture. Examples of voice input devices include a microphone. Furthermore, examples of gesture input devices include an imaging device that captures an image of a supplier user's gesture.

For example, when the user apparatus 10 is a mechanical apparatus operated by a supplier user to work, the data obtaining device 15 obtains data on at least one of the condition of the mechanical apparatus, the condition of the surrounding environment of the mechanical apparatus, and the condition of the operator (supplier user) of the mechanical apparatus. The data obtaining device 15 includes, for example, various types of sensors. Furthermore, the data obtaining device 15 may also include, for example, a controller that generates (obtains) control data for the mechanical apparatus. The controller may be the same as or different from the controller 11. Data obtained by the data obtaining device 15 is fed into the controller 11.

The notification part 111, in response to a request signal received from the data requesting apparatus 20 by the communications device 12, notifies a supplier user of the contents of the request signal through the output device 13. Specifically, the notification part 111 notifies a supplier user of the contents of the request data specified in the request signal in a visual manner or an auditory manner through the output device 13.

The requested data obtaining part 112 obtains (generates) the requested data in response to an input signal corresponding to an input received by the input device 14. Specifically, a supplier user checks the details (specifications) of the requested data requested by the data requesting apparatus 20 through the output device 13, and makes an input (for example, inputs an operation) for obtaining (generating) the requested data through the input device 14. This enables the requested data obtaining part 112 to obtain the requested data according to the supplier user's input. The requested data obtaining part 112 transmits the obtained requested data to the data requesting apparatus 20 through the communications device 12. At this point, the requested data obtaining part 112 also transmits the identification information of a supplier user who is using the user apparatus 10 (hereinafter “user identification information”) to the data requesting apparatus 20. The user identification information is, for example, an ID (identifier) unique to each of supplier users. This enables the data requesting apparatus 20 to identify a supplier user who is using the user apparatus 10 from which the requested data have been transmitted. The original data providing part 113 provides the requested data obtaining part 112 with original data corresponding to the requested data. Specifically, the original data providing part 113 provides original data from among various data fed from the data obtaining device 15.

### <Configuration of Data Requesting Apparatus>

As illustrated in FIGS. 5 and 6, the data requesting apparatus 20 includes the controller 21 and a communications device 22.

The controller 21 performs various kinds of control with respect to the data requesting apparatus 20.

As illustrated in FIG. 5, the controller 21 includes a data requesting part 211, an original data providing part 212, an original data storage part 213, a requested data storage part 214, a point processing part 215, and a ledger storage part 216. Furthermore, as illustrated in FIG. 6, when the original data providing part 113 is included in the user apparatus 10, the original data providing part 212 and the original data storage part 213 may be omitted. The functions of the data requesting part 211, the original data providing part 212, and the point processing part 215 are implemented by, for example, running a predetermined program installed in the secondary storage on the CPU. The program may be installed in the same manner as in the case of the user apparatus 10 as described above. Furthermore, the functions of the original data storage part 213, the requested data storage part 214, and the ledger storage part 216 are implemented by, for example, storage areas predefined in the internal memory of the controller 21.

The functions of the data requesting apparatus 20 (the controller 21) may be divided between or among two or more apparatuses. For example, the functions of the data requesting part 211, the original data providing part 212 and the original data storage part 213, the requested data storage part 214, and the point processing part 215 and the ledger storage part 216 may be installed in apparatuses that are different from each other.

The communications device 22 connects to the communication line NW1 to perform communications with the user apparatuses 10. The communications device 22 may also connect to the communication line NW2 to perform communications with the demander user apparatuses 30.

The data requesting part 211 delivers a request signal that defines the contents of the requested data to each of the user apparatuses 10 through the communications device 22.

The data requesting part 211 may be omitted when the contents of the requested data are fixed. This is because the user apparatus 10 can determine the contents of the requested data without receiving a request signal when the contents of the requested data are pre-recorded in the internal memory of the controller 11.

The original data providing part 212 transmits original data corresponding to the requested data to the user apparatus 10 through the communications device 22.

The original data corresponding to the requested data are stored in the original data storage part 213. The original data may be, for example, operation data uploaded to the data requesting apparatus 20 from industrial machines. Examples of operation data may include at least one of data on the condition of an industrial machine during operation, data on the condition of the surrounding environment of an industrial machine, and data on the condition of an operator of an industrial machine.

The requested data storage part 214 stores the requested data that the communications device 22 receives from the user apparatus 10.

The point processing part 215 executes a process related to giving points, etc., with respect to a predetermined point program (hereinafter simply “point program”). In response to obtaining (receiving) the requested data from the user apparatus 10, the point processing part 215 executes a process related to giving a point to a supplier user who is using the user apparatus 10 from which the requested data have been transmitted (hereinafter “transmitter user”). Specifically, the point processing part 215 executes a process to give (add) a point as an incentive to the point balance of the transmitter user in a point ledger stored in the ledger storage part 216 from predetermined resources. This makes it possible to have more supplier users take part in the activity of obtaining (generating) the requested data because of the effect produced by providing an incentive (point). Therefore, the data requesting apparatus 20 can more easily collect more requested data.

The point program may be either a point program independently operated in the data collection system 1 or a general-purpose point program operated by another organization. In the latter case, the ledger storage part 216 may be omitted, and the point processing part 215 may ask a server in the office of the point program or the like to give a point based on predetermined resources.

The ledger storage part 216 stores the point ledger of the point program. The point balance, etc., of each of registered supplier users are recorded in the point ledger.

The functions of the point processing part 215 and the ledger storage part 216 may be transferred to the user apparatus 10. In this case, with the application of Distributed Ledger Technology, each of the user apparatuses 10 may, in response to updating the point ledger, transmit the details of the updated point ledger to the other user apparatuses 10 to have the details of the point ledger shared by the entirety.

Thus, according to this embodiment, the input device 14 (an example of an input part) receives an input from a supplier user. Furthermore, the requested data obtaining part 112 (an example of a data obtaining part) obtains requested data (for example, requested data related to an industrial machine) that satisfy a predetermined condition according to the input received by the input device 14. When the requested data obtaining part 112 obtains requested data that satisfy a predetermined condition, the point processing part 215 (an example of an incentive providing part) executes a process related to providing a supplier user with an incentive, namely, a process to add a point to the point balance of a supplier user.

This enables the data requesting apparatus 20 to motivate a supplier user to cooperate in obtaining the requested data. Therefore, the data requesting apparatus 20 can, for example, collect the requested data with verified identity that satisfy a predetermined condition required in an analysis with the provision of an incentive for a supplier user.

The incentive provided for a supplier user may be other than giving (adding) a point to the point balance of the supplier user in the point program. For example, the incentive provided for a supplier user may be the delivery of a predetermined coupon to a user terminal (for example, a smartphone or the like) used by the supplier user. In this case, the controller 21 executes, as a process related to the provision of an incentive, a process to request, through the communications device 22, a delivery server that delivers a coupon to deliver a coupon to a specific user terminal. Furthermore, for example, the incentive provided for a supplier user may also be the right to win or the right to the increased probability of winning goods or services provided in an online (web) lottery or an invitation to an invitational lottery. Furthermore, for example, the incentive provided for a supplier user may also be cash return instead of point return. Furthermore, for example, the incentive provided for a supplier user may also be any benefit that a supplier user can receive online. Examples of benefits that a supplier user can receive online include the provision of a “like” in the data collection system 1 or other online systems, the right to be upgraded to an upper tier among multiple tiers, the provision of a point for upgrading, and an increase in the rate of provision of points due to upgrading.

### Specific Examples of Methods of Collecting Requested Data

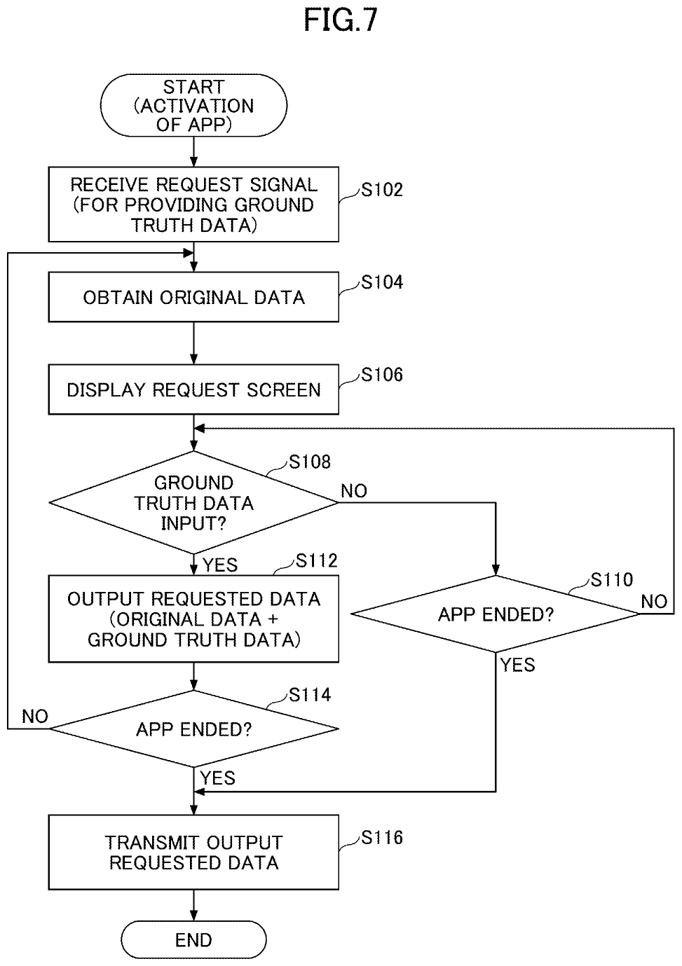

Next, specific examples of methods of collecting the requested data are illustrated with reference to FIGS. 7 through 17.

### First Example Method of Collecting Requested Data

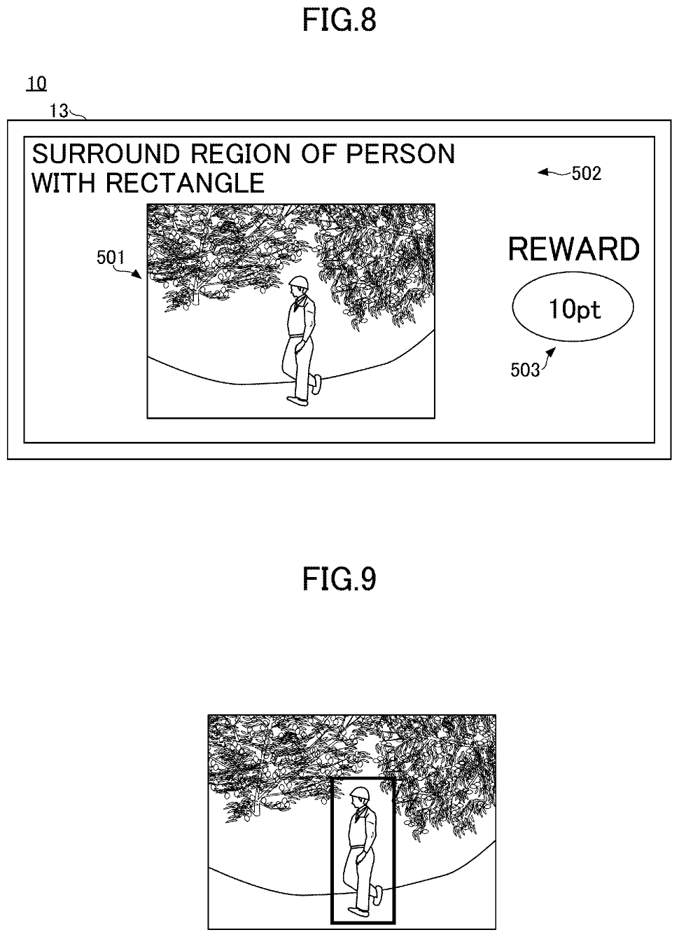

FIG. 7 is a flowchart schematically illustrating a first example of a process related to obtaining the requested data executed by the user apparatus 10 (the controller 11) (hereinafter, “requested data obtaining process”). FIG. 8 is a diagram illustrating a first example of a screen that communicates the contents of the requested data (hereinafter “request screen”) displayed on the output device 13 (display device). FIG. 9 is a diagram illustrating an example of the requested data obtained by the user apparatus 10 (the requested data obtaining part 112).

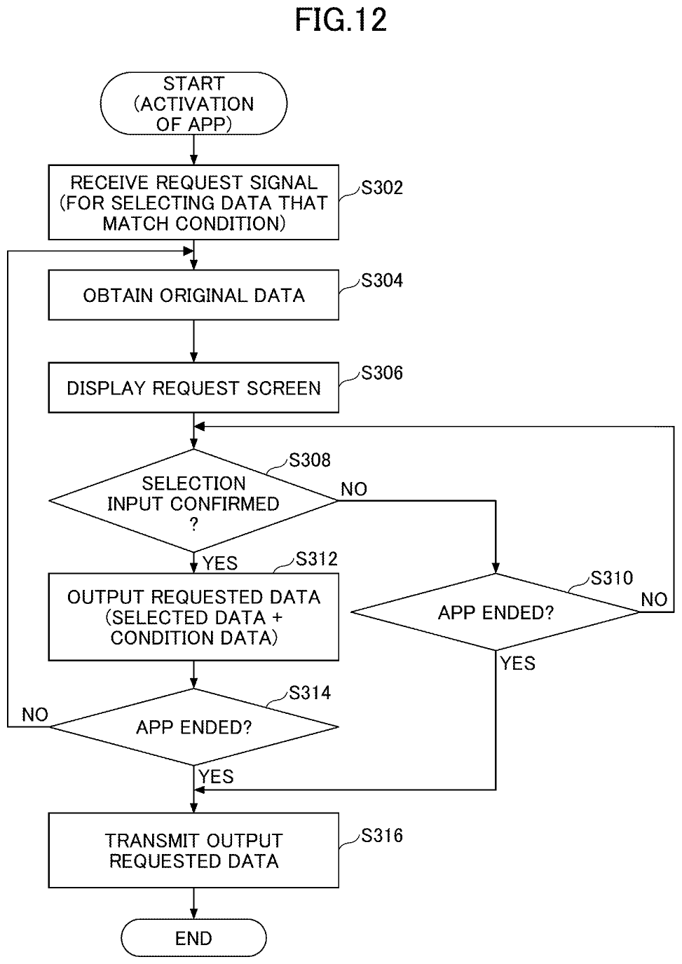

According to this example, in the user apparatus 10, a predetermined application program (hereinafter simply “app”) is started in response to a predetermined input to the input device 14 to enable the function of the requested data obtaining part 112, etc. Then, in response to the start of the app, a start signal is transmitted to the data requesting apparatus 20. This flowchart is started in response to the start of the app. The same is true for the cases of third through fifth examples (FIGS. 12, 14 and 16) as described below.

As illustrated in FIG. 7, at step S102, the notification part 111 receives (obtains) a request signal that is transmitted from the data requesting apparatus 20 in response to the start signal through the communications device 12. The request signal defines the requested data that are a combination of original data and metadata related to the original data that satisfy a predetermined condition. Specifically, the request signal defines the requested data that are a combination of original data and ground truth data for supervised learning using the original data. For example, in the case of performing machine learning (supervised learning) for creating a model for determining the presence or absence of a predetermined object (for example, a person) in an image, data representing the presence or absence of the predetermined object in image data serving as original data correspond to ground truth data. Furthermore, for example, in the case of performing machine learning for identifying not only the presence or absence of a predetermined object but also an image region in which the predetermined object is included, data identifying the image region of the predetermined object included in image data serving as original data correspond to ground truth data. Furthermore, for example, in the case of performing machine learning for creating a model for determining the presence or absence of an abnormality from the contents of the operation data of an industrial machine, data representing whether the operation data serving as original data correspond to the normal time or the abnormal time of the industrial machine correspond to ground truth data.

In response to the completion of the process of step S102, the controller 11 proceeds to step S104.

The request signal may be delivered from the data requesting apparatus 20 to the user apparatus 10 before the start of this flowchart. In this case, the process of step S102 is omitted.

At step S104, the notification part 111 obtains the original data. In response to the completion of the process of step S104, the controller 11 proceeds to step S106.

At step S106, the notification part 111 displays a request screen on the output device 13 (display device) based on data, etc., obtained in the processes of steps S102 and S104.

For example, as illustrated in FIG. 8, the request screen includes original data information 501, requested data information 502, and incentive information 503.

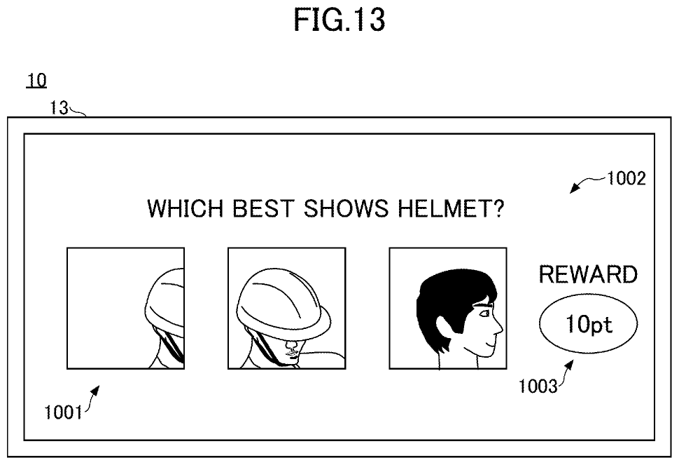

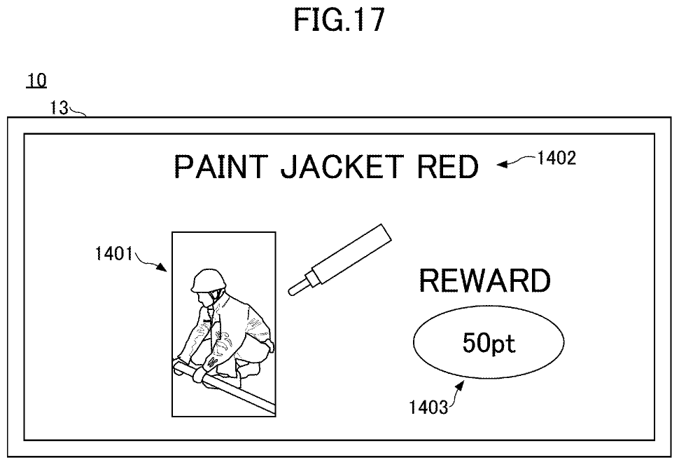

The original data information 501 shows the contents (image data) of the original data. According to this example, the original data information 501 correspond to image data captured by an image capturing device mounted on a work machine, and a worker (person) present in a region relatively close to the work machine is shown in the image data. In this case, for example, the user apparatus 10 may be the work machine, and as described above, the original data providing part 113 may provide the notification part 111 and the requested data obtaining part 112 with image data obtained at the data obtaining device 15 (image capturing device). A supplier user who sits in the operator seat of the work machine (for example, an operator of the work machine) can cooperate in obtaining the requested data during a break or the like using the output device 13 and the input device 14 installed near the operator seat. The same may be true for the cases of the below-described third example (FIG. 13) and the fifth example (FIG. 17).

The requested data information 502 shows the contents of the requested data. According to this example, the requested data information 502 reads: “SURROUND REGION OF PERSON WITH RECTANGLE”. This enables the supplier user to understand that a figure (rectangle) that identifies an image region in which the person of the image data is included may be drawn as ground truth data to be combined with the original data (image data).

The incentive information 503 shows the details of an incentive (the amount of points) to be obtained in the case of cooperating in obtaining the requested data, namely, in the work of drawing a figure that identifies an image region in which the person of the image data is included. According to this example, the incentive information 503 says that ten points are given as an incentive. This enables the supplier user to understand the details of an incentive obtained by cooperating in obtaining the requested data. Therefore, the supplier user can determine whether to cooperate in obtaining the requested data, taking the details of an incentive into account.

Referring back to FIG. 7, in response to the completion of the process of step S106, the controller 11 proceeds to step S108.

At step S108, the requested data obtaining part 112 determines whether ground truth data have been input through the input device 14. The requested data obtaining part 112 proceeds to step S110 if no ground truth data have been input through the input device 14, and proceeds to step S112 if ground truth data have been input through the input device 14.

At step S110, the controller 11 determines whether a predetermined input for ending the app (hereinafter “app ending input”) has been made through the input device 14. The controller 11 returns to step S108 if no app ending input has been made through the input device 14, and proceeds to step S116 if the app ending input has been made through the input device 14.

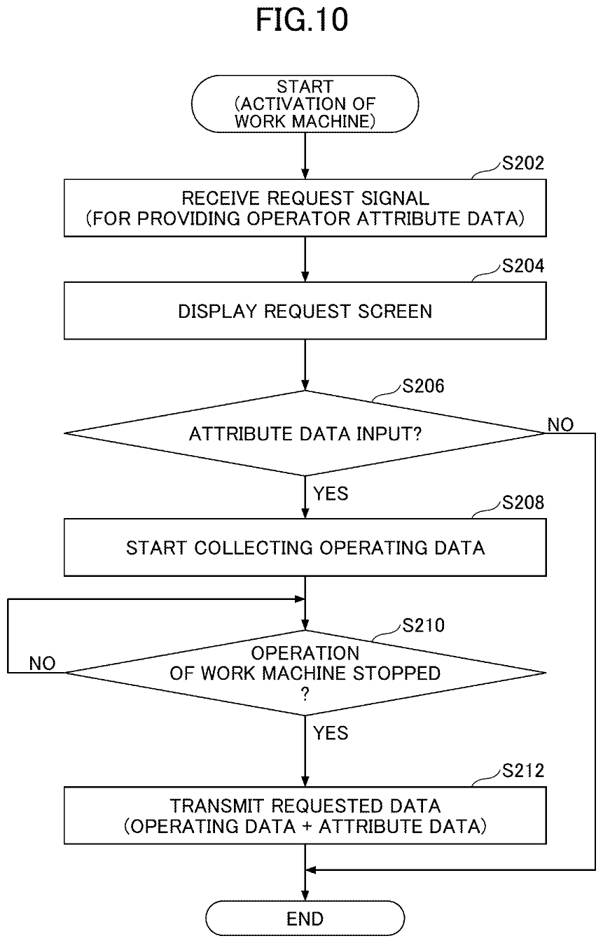

At step S112, the requested data obtaining part 112 outputs the requested data that are a combination of the original data and the ground truth data. The requested data may be a dataset in which the original data and the ground truth data (metadata) are independently combined or may be data in which the ground truth data (metadata) are provided for the original data through tagging, labeling, or the like. The same may be true for the cases of a second example through the fifth example (FIGS. 10 through 17) as described below.

For example, as illustrated in FIG. 9, based on the request screen of FIG. 8, the requested data in which a figure (rectangle) that identifies an image region in which a person is included as the ground truth data is drawn over image data serving as the original data is output. Furthermore, the output requested data may be a dataset in which the image data (original data) and the ground truth data representing a pixel range that identifies a region in which a person in the image data is included are combined. The output requested data may also be data in which the ground truth data representing a pixel range that identifies a region in which a person in the image data is included are provided for the image data (original data).

Referring back to FIG. 7, in response to the completion of the process of step S112, the controller 11 proceeds to step S114.

At step S114, the controller 11 determines whether an app ending input has been made through the input device 14. The controller 11 returns to step S104 to repeat the process of obtaining the requested data (steps S104 through S112) for new original data if no app ending input has been made through the input device 14. The controller 11 proceeds to step S116 if the app ending input has been made through the input device 14.

At step S116, the requested data obtaining part 112 transmits the output requested data to the data requesting apparatus 20 through the communications device 12. This enables the data requesting apparatus 20 to obtain the output requested data. If there are no output requested data, the process of step S116 is omitted.

In response to the completion of the process of step S116, the controller 11 ends the process of the flowchart of this time.

Thus, according to this example, the original data providing parts 113 and 212 provide original data. Furthermore, the notification part 111 notifies a supplier user of the contents of the original data through the output device 13. The requested data obtaining part 112 obtains the requested data that satisfy a predetermined condition based on the original data, according to an input with respect to the original data received by the input device 14.

This enables the data collection system 1 (the data requesting apparatus 20) to collect the requested data based on the original data.

Furthermore, according to this example, the requested data obtaining part 112 obtains the requested data that are a combination of the original data and metadata that satisfy a predetermined condition, generated according to an input with respect to the original data received by the input device 14.

This enables the data collection system 1 (the data requesting apparatus 20) to collect the requested data including metadata that satisfy a predetermined condition required in an analysis, etc.

Furthermore, according to this example, the metadata combined with the original data are data that represent ground truth for supervised learning (ground truth data).

This enables the data collection system 1 (the data requesting apparatus 20) to collect the requested data that may be used as labeled training data for supervised learning.

For example, according to industrial machines, the entry of an object that is a monitoring target (for example, a person) into a nearby surrounding area may reduce safety. Therefore, according to industrial machines, a process of determining the presence or absence of an object that is a monitoring target, the relative position of a monitoring target, etc., may be executed based on data on objects in an area surrounding an industrial machine (for example, the data of a captured image of a situation in an area surrounding an industrial machine).

In contrast, according to this example, the data collection system 1 (the data requesting apparatus 20) can collect the requested data that include ground truth data representing an image region in which a monitoring target (a person) is present in the original data (image data) representing a situation in an area surrounding an industrial machine. Therefore, by performing supervised learning using the collected requested data to create a trained model or to additionally learn a trained model to update a trained model, it is possible to obtain a trained model for determining the presence or absence and the location of a monitoring target and to apply the trained model to industrial machines.

### Second Example Method of Collecting Requested Data

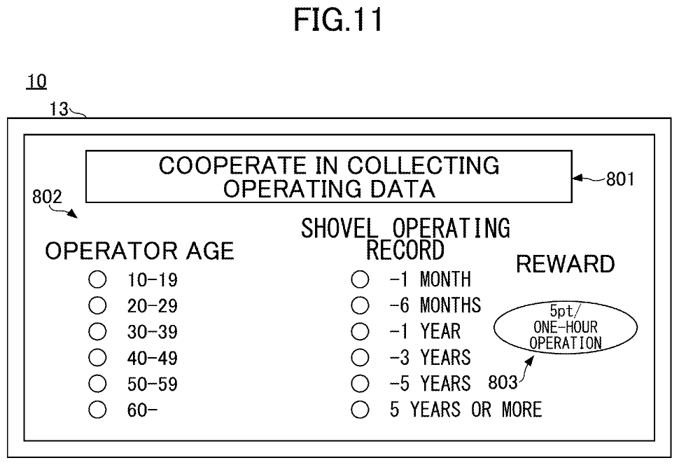

FIG. 10 is a flowchart schematically illustrating a second example of the requested data obtaining process executed by the user apparatus 10 (the controller 11). FIG. 11 is a diagram illustrating a second example of the request screen displayed on the output device 13.

According to this example, the user apparatus 10 is a predetermined industrial machine (for example, a work machine such as a shovel), and a supplier user is an operator of the industrial machine. The user apparatus 10 (industrial machine) is activated to transmit a start signal to the data requesting apparatus 20 through the communications device 12. This flowchart starts in response to the activation of the industrial machine (for example, the turning-on of a key switch, the turning-on of power, or the like).

As illustrated in FIG. 10, at step S202, the notification part 111 receives (obtains) a request signal that is transmitted from the data requesting apparatus 20 in response to the start signal through the communications device 12. The request signal defines the requested data that are a combination of original data and metadata related to the original data that satisfy a predetermined condition. Specifically, the request signal defines the requested data in which data on the attributes of the operator using (operating) the industrial machine (hereinafter “operator attribute data”) are combined with operation data (operating data) during operation from the start to the stop of the industrial machine as original data. The attributes of the operator include, for example, age and years of experience as an operator (operating record).

In response to the completion of the process of step S202, the controller 11 proceeds to step S204.

The request signal may be delivered from the data requesting apparatus 20 to the user apparatus 10 before the start of this flowchart. In this case, the process of step S202 is omitted.

At step S204, the notification part 111 displays a request screen on the output device 13 (display device) based on the request signal obtained in the process of step S202.

For example, as illustrated in FIG. 11, the request screen includes original data information 801, metadata information 802, and incentive information 803.

The original data information 801 shows the contents of the original data included in the requested data. According to this example, the original data information 801 reads: “COOPERATE IN COLLECTING OPERATING DATA”, representing a request for the supplier user (operator)'s cooperation in collecting operating data as the original data.

The metadata information 802 shows the contents of the metadata included in the requested data. According to this example, questions about the age of the supplier user (operator) and the years of experience (operating record) of the supplier user as an industrial machine (shovel) operator are set forth in the metadata information 802. By having the supplier user answer the questions through the input device 14, the user apparatus 10 can obtain data on answers to the questions as operator attribute data (metadata related to operating data).

The incentive information 803 shows the details of an incentive (the amount of points) to be obtained in the case of cooperating in obtaining the requested data, namely, in collecting operating data. According to this example, the incentive information 803 says that five points are given as an incentive for cooperating in collecting an hour's operating data. This enables the supplier user to know the details of an incentive that is obtained by cooperating in obtaining the requested data. Therefore, the supplier user can determine whether to cooperate in obtaining the requested data, taking the details of an incentive into account.

Referring back to FIG. 10, in response to the completion of the process of step S204, the controller 11 proceeds to step S206.

At step S206, the controller 11 determines whether operator attribute data have been input through the input device 14. The controller 11 proceeds to step S208 if operator attribute data have been input, and ends the process of the flowchart of this time if no operator attribute data have been input (for example, if the content of the output device 13 is changed from a request screen to another screen without an input of operator attribute data).

At step S208, the original data providing part 113 starts to collect operating data as the original data. In response to the completion of the process of step S208, the controller 11 proceeds to step S210.

At step S210, the controller 11 determines whether the operation of the industrial machine is stopped. For example, the controller 11 determines that the operation of the industrial machine is stopped when the key switch or power switch of the industrial machine is turned off. The controller 11 proceeds to step S212 if the operation of the industrial machine is stopped, and waits until the operation is stopped if the operation is not stopped (repeats the process of this step until the operation is stopped).

At step S212, the requested data obtaining part 112 obtains the requested data that are a combination of the operating data (original data) collected by the original data providing part 113 in and after the process of step S208 and the operator attribute data (metadata). Then, the requested data obtaining part 112 transmits the obtained requested data to the data requesting apparatus 20 through the communications device 12. This enables the data requesting apparatus 20 to obtain the requested data that is a combination of the operating data as the original data and the operator attribute data as metadata.

Thus, according to this example, the requested data obtaining part 112 obtains the requested data that are a combination of the original data and metadata that satisfy a predetermined condition, generated according to an input with respect to the original data received by the input device 14. Specifically, the original data are operating data during the operation of the industrial machine (data on at least one of the condition of the industrial machine, the condition of the surrounding environment of the industrial machine, and the condition of the operator of the industrial machine), and the metadata are data on attributes of the operator of the industrial machine.

This enables the data collection system 1 (the data requesting apparatus 20) to collect the requested data that make it possible to analyze, for example, the correlation between the operator of the industrial machine and the operating data of the industrial machine. Therefore, it is possible to evaluate the operator from the results of the analysis and to clarify the characteristics of a skilled operator from the results of the analysis to use them for fostering operators.

### Third Example Method of Collecting Requested Data

FIG. 12 is a flowchart schematically illustrating a third example of the requested data obtaining process executed by the user apparatus 10 (the controller 11). FIG. 13 is a diagram illustrating a third example of the request screen displayed on the output device 13.

As illustrated in FIG. 12, at step S302, the notification part 111 receives (obtains) a request signal that is transmitted from the data requesting apparatus 20 in response to a start signal through the communications device 12. The request signal defines the requested data to be selected as data that match a predetermined condition from among provided multiple original data.

In response to the completion of the process of step S302, the controller 11 proceeds to step S304.

At step S304, the notification part 111 obtains multiple original data items. In response to the completion of the process of step S304, the controller 11 proceeds to step S306.

At step S306, the notification part 111 displays a request screen on the output device 13 (display device) based on the data obtained in the processes of steps S302 and S304, etc.

For example, as illustrated in FIG. 13, the request screen includes original data information 1001, requested data information 1002, and incentive information 1003.

The original data information 1001 shows the contents of multiple (three according to this example) original data (multiple image data) items specified as options. According to this example, the original data information 1001 corresponds to multiple (three) image data items captured by an image capturing device mounted on a work machine, and a worker (person) is seen in each of the image data.

The requested data information 1002 shows the contents of the requested data, and specifically shows a predetermined condition (selection condition) for selecting the requested data from among the multiple original data (image data) items. According to this example, the requested data information 1002 reads: “WHICH BEST SHOWS HELMET?” This enables a supplier user to understand that an image data item which best shows a helmet may be selected from among the multiple original data (image data) items.

While a selection condition for selecting one original data item as the requested data from among multiple original data items is set according to this example, a selection condition for selecting two or more original data items as the requested data from among multiple original data items may be set.

The incentive information 1003 shows the details of an incentive (the amount of points) to be obtained in the case of cooperating in the work of obtaining the requested data, namely, selecting and obtaining an image in which a helmet is best seen from among multiple image data. According to this example, the incentive information 1003 says that ten points are given as an incentive. This enables the supplier user to know the details of an incentive that is obtained by cooperating in obtaining the requested data. Therefore, the supplier user can determine whether to cooperate in obtaining the requested data, taking the details of an incentive into account.

Referring back to FIG. 12, in response to the completion of the process of step S306, the controller 11 proceeds to step S308.

At step S308, the controller 11 determines whether an input to select an original data item from among the multiple original data items has been made through the input device 14 and confirmed. The controller 11 proceeds to step S310 if no input to select an original data item from among the multiple original data items has been made through the input device 14, or the input has been made but is not confirmed. In contrast, the controller 11 proceeds to step S312 if an input to select an original data item from among the multiple original data items has been made through the input device 14 and confirmed.

At step S310, the controller 11 determines whether an input to end the app has been made through the input device 14. The controller 11 returns to step S308 if no input to end the app has been made through the input device 14, and proceeds to step S316 if an input to end the app has been made.

At step S312, the requested data obtaining part 112 outputs, as the requested data, the original data item selected from among the multiple original data items according to the supplier user's input received by the input device 14. For example, the requested data obtaining part 112 may output, as the requested data, data that are a combination of the selected original data and data representing the respective selection conditions (condition data).

In response to the completion of step S312, the controller 11 proceeds to step S314.

At step S314, the controller 11 determines whether an input to end the app has been made through the input device 14. If no input to end the app has been made through the input device 14, the controller 11 returns to step S304 to repeat the process of obtaining the requested data (steps S304 through S312) for new original data. The controller 11 proceeds to step S316 if an input to end the app has been made through the input device 14.

At step S316, the requested data obtaining part 112 transmits the output requested data to the data requesting apparatus 20 through the communications device 12. This enables the data requesting apparatus 20 to obtain the output requested data. If there are no output requested data, the process of step S316 is omitted.

In response to the completion of the process of step S316, the controller 11 ends the process of the flowchart of this time.

Thus, according to this example, the requested data obtaining part 112 selectively obtains data item that satisfy a predetermined condition from multiple original data, according to a selection input with respect to the multiple original data received by the input device 14.

This enables the data collection system 1 (the data requesting apparatus 20) to selectively collect, as the requested data, original data that satisfy a predetermined condition required in an analysis, etc., from among multiple original data.

For example, it is often the case that a person (worker) wearing a helmet works in an area surrounding an industrial machine. In such a case, by applying a trained model that recognizes the presence or absence of a helmet, the position of a helmet, etc., from data on a captured image of a situation in the area surrounding the industrial machine to the industrial machine, it is possible to identify the presence or absence and the location of a worker as a monitoring target.

According to this example, the data collection system 1 (the data requesting apparatus 20) can selectively collect image data showing a helmet from among a group of image data representing a situation in an area surrounding an industrial machine. Therefore, by performing supervised learning, creating a trained model, or updating a trained model by additionally learning a trained model, using an image data group showing a helmet, it is possible to obtain a trained model for determining the presence or absence and the location of a monitoring target and apply the trained model to industrial machines.

### Fourth Example Method of Collecting Requested Data

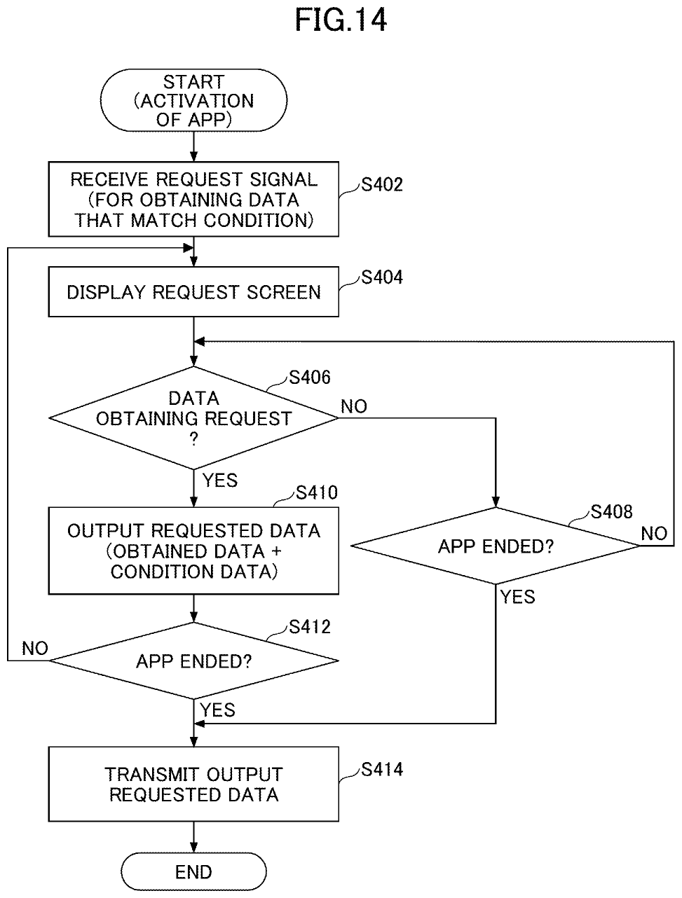

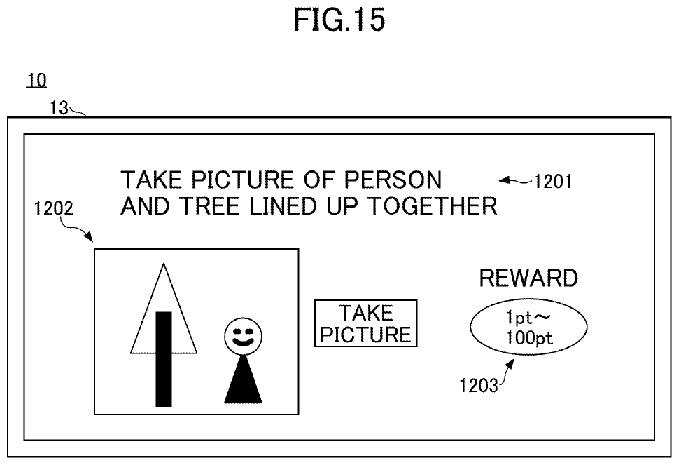

FIG. 14 is a flowchart schematically illustrating a fourth example of the requested data obtaining process executed by the user apparatus 10 (the controller 11). FIG. 15 is a diagram illustrating a fourth example of the request screen displayed on the output device 13.

As illustrated in FIG. 14, at step S402, the notification part 111 receives (obtains) a request signal that is transmitted from the data requesting apparatus 20 in response to a start signal through the communications device 12. The request signal defines the requested data to be newly obtained as data that match a predetermined condition. For example, as described below, the requested data to be newly obtained may include image data that are so newly captured as to satisfy the predetermined condition. Furthermore, for example, the requested data to be newly obtained may be operation data that are collected (obtained) at an industrial machine when the predetermined condition is satisfied. Specifically, the requested data to be newly obtained may be operation data that are obtained in response to a supplier user (operator)'s predetermined input (for example, operation of a predetermined button switch) at the occurrence of an abnormality in an industrial machine serving as the user apparatus 10. Furthermore, the requested data to be newly obtained may be operation data that are obtained in response to the supplier user (operator)'s predetermined input at the detection of a defective product in a machine tool, an injection molding machine, or the like. In these cases, the requested data obtaining part 112 can obtain operation data when the predetermined condition is satisfied by retroactively extract operation data temporarily stored in a ring buffer and record them in a nonvolatile storage, for example.

In response to the completion of the process of step S402, the controller 11 proceeds to step S404.

At step S404, the notification part 111 displays a request screen on the output device 13 (display device) based on the data obtained in the process of step S402.

For example, as illustrated in FIG. 15, the request screen includes requested data information 1201 and 1202 and incentive information 1203.

The requested data information 1201 shows the contents of the requested data as text information, and specifically, shows the details of a predetermined condition to be satisfied by the requested data to be newly obtained (an obtaining condition). According to this example, the requested data information 1201 reads: “TAKE PICTURE OF PERSON AND TREE LINED UP TOGETHER”. This enables the supplier user to understand, for example, that a picture (image data) of a person and a tree lined up together may be taken (obtained) using a camera installed in the user apparatus 10 such as a smartphone.

The requested data information 1202 shows the contents of the requested data as visual information. According to this example, the requested data information 1202 is an illustration image imitating a picture of a person and a tree lined up together. This enables the supplier user to clearly understand what kind of picture (image data) to obtain.

The incentive information 1203 shows the details of an incentive (the amount of points) to be obtained in the case of cooperating in obtaining the requested data, namely, in obtaining (taking) a picture of a person and a tree lined up together. According to this example, the incentive information 1203 says that points in the range of one point to one hundred points are given as an incentive. This enables the supplier user to know the details of an incentive that is obtained by cooperating in obtaining the requested data. Therefore, the supplier user can determine whether to cooperate in obtaining the requested data, taking the details of an incentive into account. In this case, the point processing part 215 changes the amount of points to be given (added) to the point balance of the supplier user in the point ledger according to the contents (quality) of the requested data obtained by the requested data obtaining part 112. This enables the data collection system 1 (the user apparatus 10) to encourage the supplier user to obtain the requested data with higher quality.

The supplier user may, for example, newly capture an image of a person and a tree lined up and make a predetermined input to request the captured image data to be obtained as the requested data (hereinafter “input to request obtaining”) through the input device 14. Furthermore, the supplier user may select image data of a person and a tree lined up from among image data already stored in the user apparatus 10 (for example, a smartphone or the like) and make an input to request obtaining the selected image data through the input device 14. This enables the user apparatus 10 (the requested data obtaining part 112) to obtain, in response to an input to request obtaining received by the input device 14, corresponding image data as the requested data.

Referring back to FIG. 14, in response to the completion of the process of step S404, the controller 11 proceeds to step S406.

At step S406, the controller 11 determines whether an input to request obtaining data has been received through the input device 14. The controller 11 proceeds to step S408 if no input to request obtaining data has been received through the input device 14, and proceeds to step S410 if an input to request obtaining data has been received through the input device 14.

At step S408, the controller 11 determines whether an input to end the app has been made through the input device 14. The controller 11 returns to step S406 if no input to end the app has been made through the input device 14, and proceeds to step S414 if an input to end the app has been made through the input device 14.

At step S410, the requested data obtaining part 112 outputs data specified by the obtaining request received through the input device 14 (obtained data) as the requested data. For example, the requested data obtaining part 112 may output data that are a combination of the obtained data and data representing the obtaining condition (condition data) as the requested data.

In response to the completion of the process of step S410, the controller 11 proceeds to step S412.

At step S412, the controller 11 determines whether an input to end the app has been made through the input device 14. If no input to end the app has been made through the input device 14, the controller 11 returns to step S404 to newly repeat the process of obtaining the requested data (the process of steps S404 through S410). If an input to end the app has been made through the input device 14, the controller 11 proceeds to step S414.

At step S414, the requested data obtaining part 112 transmits the output requested data to the data requesting apparatus 20 through the communications device 12. This enables the data requesting apparatus 20 to obtain the output requested data. If there are no output requested data, the process of step S414 is omitted.

Thus, according to this example, the requested data obtaining part 112 obtains the requested data that satisfy a new predetermined condition (obtaining condition) according to an input received by the input device 14.

This enables the data collection system 1 (the data requesting apparatus 20) to collect the requested data that satisfy a predetermined condition required in an analysis, etc., without original data.

For example, a work machine may work in a location surrounded by trees (for example, a mountain area or the like). Therefore, in the case of creating a trained model for identifying a person (worker) from among the data of captured images of a situation in an area surrounding the work machine, it is desirable to avoid a situation where a background tree in image data is wrongly identified as a person or a person among background trees is overlooked as much as possible.

According to this example, it is possible to intensively collect image data of a person and a tree lined up together. Based on this, machine learning (supervised learning) is performed using image data of a person and a tree lined up together as labeled training data, so that it is possible to obtain a trained model that is highly accurate in identifying a person from image data showing a person and a tree together and apply the trained model to work machines used in a mountain area or the like.

### Fifth Example Method of Collecting Requested Data

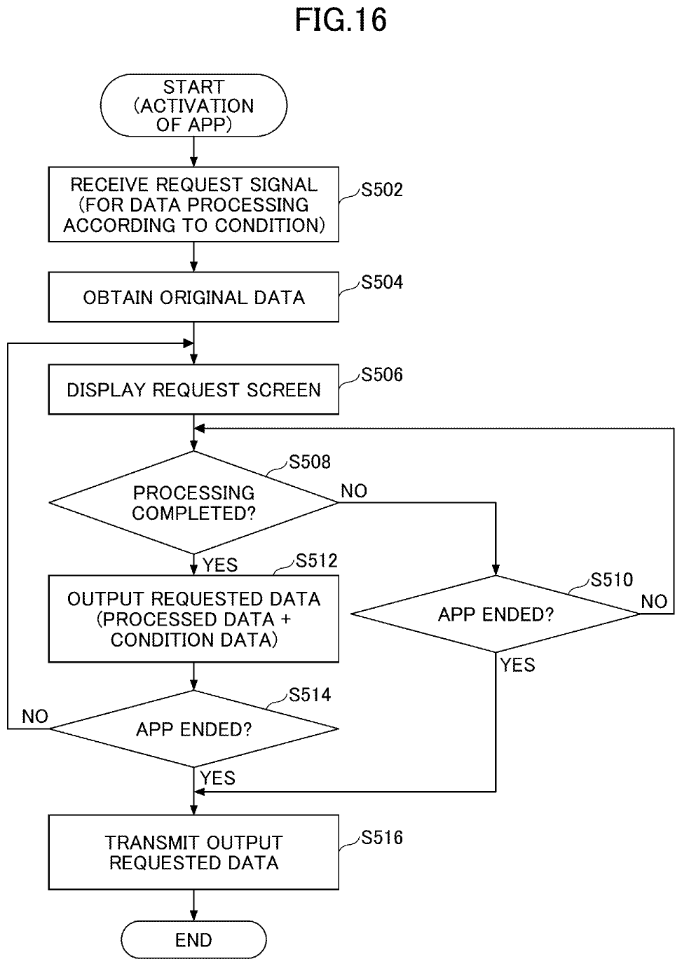

FIG. 16 is a flowchart schematically illustrating a fifth example of the requested data obtaining process executed by the user apparatus 10 (the controller 11). FIG. 17 is a diagram illustrating a fifth example of the request screen displayed on the output device 13.

At step S502, the notification part 111 receives (obtains) a request signal that is transmitted from the data requesting apparatus 20 in response to a start signal through the communications device 12. The request signal defines the requested data as processed data subjected to processing that satisfies a predetermined condition with respect to the original data. For example, the processed data may include image data subjected to processing that changes the color of part of the original data (image data) to another color. Furthermore, for example, the processed data may include data subjected to processing that anonymizes personal information included in the original data. Specifically, the processed data may be image data subjected to processing that blurs the face part of the original data (image data).

In response to the completion of the process of step S502, the controller 11 proceeds to step S504.

At step S504, the notification part 111 obtains the original data. In response to the completion of the process of step S504, the controller 11 proceeds to step S506.

At step S506, the notification part 111 displays a request screen on the output device 13 (display device) based on the data obtained in the processes of steps S502 and S504.

For example, as illustrated in FIG. 17, the request screen includes original data information 1401, requested data information 1402, and incentive information 1403.

The original data information 1401 shows the contents of the original data (image data). According to this example, the original data information 1401 corresponds to image data captured by an image capturing device mounted on a work machine, and a worker (person) is shown in the image data.

The requested data information 1402 shows the contents of the requested data, and specifically, shows a predetermined condition to be satisfied by processed data corresponding to the original data (a processing condition). According to this example, the requested data information 1402 reads: “PAINT JACKET RED”. This enables a supplier user to understand that the jacket of the worker in the image data may be processed to be red by an input through the input device 14.

The incentive information 1403 shows the details of an incentive (the amount of points) to be obtained in the case of cooperating in obtaining the requested data, namely, in processing the image data (obtaining image data including a worker with a red jacket). According to this example, the incentive information 1403 says that ten points are given as an incentive. This enables the supplier user to know the details of an incentive that is obtained by cooperating in obtaining the requested data. Therefore, the supplier user can determine whether to cooperate in obtaining the requested data, taking the details of an incentive into account.

Referring back to FIG. 16, in response to the completion of the process of step S506, the controller 11 proceeds to step S508.

At step S508, the controller 11 determines whether the processing of the original data has been completed. The controller 11 proceeds to step S510 if the processing of the original data has not been completed, and proceeds to step S512 if the processing of the original data has been completed.

At step S510, the controller 11 determines whether an input to end the app has been made through the input device 14. The controller 11 returns to step S508 if no input to end the app has been made through the input device 14, and proceeds to step S516 if an input to end the app has been made through the input device 14.

At step S512, the requested data obtaining part 112 outputs data subjected to processing based on the original data (processed data) as the requested data. For example, the requested data obtaining part 112 may output data that are a combination of the processed data and data representing the processing condition (condition data) as the requested data.

In response to the completion of the process of step S512, the controller 11 proceeds to step S514.

At step S514, the controller 11 determines whether an input to end the app has been made through the input device 14. If no input to end the app has been made through the input device 14, the controller 11 returns to step S504 to newly repeat the process of obtaining the requested data (the process of steps S504 through S512). If an input to end the app has been made through the input device 14, the controller 11 proceeds to step S516.

At step S516, the requested data obtaining part 112 transmits the output requested data to the data requesting apparatus 20 through the communications device 12. This enables the data requesting apparatus 20 to obtain the output requested data. If there are no output requested data, the process of step S516 is omitted.

Thus, according to this example, the requested data obtaining part 112 obtains the requested data subjected to processing that satisfies a predetermined condition with respect to the original data (processing condition) according to an input with respect to the original data received by the input device 14.

This enables the data collection system 1 (the data requesting apparatus 20) to collect the requested data in which processing that satisfies a predetermined condition required in an analysis, etc., is performed on the original data (processed data).

For example, a worker who works around an industrial machine may wear a red jacket. In this case, by applying, to the industrial machine, a trained model for identifying the presence or absence of a red jacket, the position of a red jacket, etc., from among captured image data of a situation in an area surrounding the industrial machine, it is possible to identify the presence or absence and the location of a worker as a monitoring target.

According to this example, the data collection system 1 (the data requesting apparatus 20) can intensively collect image data including a worker whose jacket color has been processed to be red. Therefore, by performing supervised learning using a group of image data showing a worker wearing a red jacket to create a trained model or to additionally learn a trained model to update a trained model, it is possible to obtain a trained model for determining the presence or absence and the location of a monitoring target and to apply the trained model to industrial machines.

### Other Example Methods of Collecting Requested Data

For example, the data collection system 1 (the data requesting apparatus 20) may collect video data instead of or in addition to still image data as the requested data. Furthermore, the data collection system 1 may collect sound data or data that are a combination of image data (at least one of still image data and video data) and sound data instead of or in addition to image data as the requested data.

Furthermore, for example, the data collection system 1 (the data requesting apparatus 20) may collect the requested data that are a combination of image data (a still image or a video) as the original data and metadata including text information that is an explanation of the image data. The explanation of the image data may include a keyword or a text (description) that explains the image data. For example, the explanation of the image data includes attributes (for example, “a young male”), feelings (for example, “angry”), expressions (for example, “smiling”), the details of action (for example, “at the point of leaving for school”) of a person shown in the image data. Furthermore, the explanation of the image data includes the location, conditions, weather, etc., of a background shown in the image data. Furthermore, when the image data are image data captured by a work machine (for example, a shovel), for example, the explanation of the image data may include an explanation of the working status of a specific function of the work machine at the time (for example, “the function of detecting a person around the work machine is wrongly detecting an object other than a person”).

### Another Specific Example of Configuration of Data Collection System

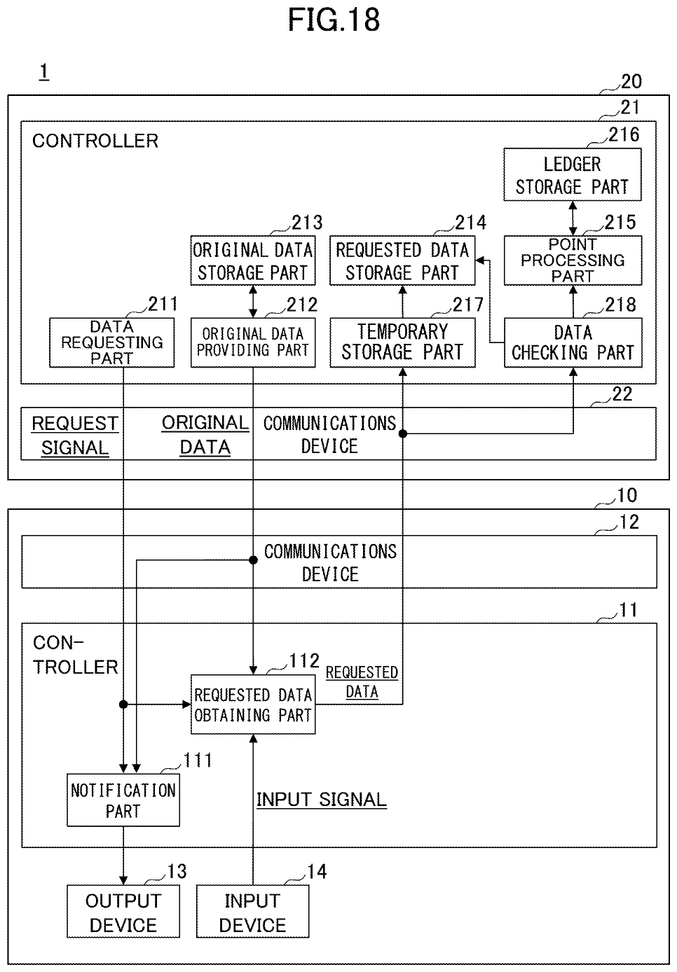

Next, another specific example of the configuration of the data collection system is described with reference to FIG. 18.

FIG. 18 is a block diagram illustrating yet another example of the configuration of the data collection system 1. The following description focuses on differences from the example (FIG. 5) and another example (FIG. 6) as described above.

As illustrated in FIG. 18, the data requesting apparatus 20 (the controller 21) includes a temporary storage part 217 and a data checking part 218 in addition to the configuration of FIG. 5.

The temporary storage part 217 and the data checking part 218, which are added to the configuration of FIG. 5 according to this example, may also be added to the configuration of FIG. 6.

The requested data received from the user apparatus 10 by the communications device 22 are temporarily stored in the temporary storage part 217. The requested data that are stored in the temporary storage part 217 even after passage of a certain period of time may be erased.

The data checking part 218 checks (determines) whether the requested data received from the user apparatus 10 satisfy a predetermined condition defined by the data requesting part 211. If the requested data received from the user apparatus 10 satisfy the predetermined condition, the data checking part 218 so notifies the point processing part 215 and stores the target requested data temporarily stored in the temporary storage part 217 in the requested data storage part 214. In contrast, if the requested data received from the user apparatus 10 do not satisfy the predetermined condition, the data checking part 218 so notifies the point processing part 215. As a result, the requested data temporarily stored in the temporary storage part 217 and not satisfying the predetermined condition are erased. Furthermore, if the requested data received from the user apparatus 10 do not satisfy the predetermined condition, the data checking part 218 may actively erase the target requested data temporarily stored in the temporary storage part 217. As a result, of the data received from the user apparatus 10 as the requested data, only the requested data determined to actually satisfy the predetermined condition are stored in the requested data storage part 214.

For example, the data checking part 218 may determine whether the requested data satisfy the predetermined condition by inputting the requested data to a predetermined trained model.

Furthermore, for example, when the requested data are received from the user apparatus 10 used by a first supplier user (hereinafter “first user apparatus 10”), the controller 21 may cause a second supplier user different from the first supplier user to check whether the requested data satisfy the predetermined condition. In this case, the controller 21 transmits a request signal to request the user apparatus 10 used by the second supplier user (hereinafter “second user apparatus 10”) to check whether the requested data, including the requested data received from the first user apparatus 10, satisfy the predetermined condition through the communications device 22. As a result, the notification part 111 of the second user apparatus 10 (the controller 11) displays a screen requesting the requested data to be checked (hereinafter “request screen”) on the output device 13 (display device). For example, the contents of the requested data, the details of an incentive with respect to the request, etc., are displayed on the request screen. When an input with respect to a check result is received through the input device 14, the controller 11 transmits data corresponding to the details of the input with respect to the check result (hereinafter “check result data”) to the data requesting apparatus 20 through the communications device 12. As a result, the data requesting apparatus 20 can receive the check result data. Therefore, the data checking part 218 can determine whether the requested data received from the first user apparatus 10 satisfy the predetermined condition based on the check result data. Furthermore, in response to the communications device 22 receiving the check result data from the second user apparatus 10, the point processing part 215 executes a process to give (add) a predetermined amount of points to the point balance of the second supplier user in the point ledger. This makes it possible to have more supplier users to take part in the work of checking the requested data because of the effect produced by providing an incentive (points).

When the communications device 22 does not receive the check result data from the second user apparatus 10, the controller 21 may transmit a request signal to request the checking of the requested data to another user apparatus 10 corresponding to yet another supplier user through the communications device 22.

Thus, according to this example, the data checking part 218 (an example of a determination part) determines whether data obtained by the requested data obtaining part 112 satisfy a predetermined condition. In response to the data checking part 218 determining that the data obtained by the requested data obtaining part 112 satisfy the predetermined condition, the point processing part 215 executes a process related to giving a supplier user a point as an incentive.

This enables the data collection system 1 (the data requesting apparatus 20) to collect only data actually determined to satisfy a predetermined condition required in an analysis, etc. Therefore, it is possible to conduct an analysis, etc., with more efficiency.

Furthermore, according to this example, the notification part 111 of the second user apparatus 10 (an example of another notification part) notifies the second supplier user of the contents of the requested data obtained by the requested data obtaining part 112 of the first user apparatus 10. The data checking part 218 determines whether the requested data obtained by the requested data obtaining part 112 of the first user apparatus 10 satisfy a predetermined condition according to an input with respect to a check result as to whether the requested data satisfy the predetermined condition, received by the input device 14 of the second user apparatus 10 (an example of another input part).

This enables the data collection system 1 (the data requesting apparatus 20) to check whether the requested data actually satisfy a predetermined condition with the cooperation of the second supplier user.

Furthermore, according to this example, when an input with respect to a check result is received by the input device 14 of the second user apparatus 10, the point processing part 215 executes a process related to giving the second supplier user points as an incentive.

This enables the data collection system 1 (the data requesting apparatus 20) to gain the cooperation of the second supplier user in the work of checking the requested data because of the effect of the incentive. Therefore, the data collection system 1 can specifically introduce the work of checking whether the requested data actually satisfy a predetermined condition.

Furthermore, according to this example, the data checking part 218 determines whether the requested data obtained by the requested data obtaining part 112 satisfy a predetermined condition by inputting the requested data obtained by the requested data obtaining part 112 to a predetermined trained model.

This enables the data collection system 1 (the data requesting apparatus 20) to specifically check whether the requested data satisfy a predetermined condition using a trained model that can determine whether the predetermined condition is satisfied with acceptable accuracy.

### Variations and Modifications

An embodiment is described in detail above. The present disclosure, however, is not limited to the specific embodiment, and various variations and modifications may be made within the scope of the subject matter described in the claims.

For example, the data collection system 1, which mainly collects data on industrial machines according to the above-described embodiment, may also collect other than data on industrial machines. For example, the data collection system 1 may collect data on home appliances communicably connected to the data collection system 1 (the data requesting apparatus 20) via the Internet or the like. Furthermore, for example, the data collection system 1 may collect data on automobiles communicably connected to the data collection system 1 (the data requesting apparatus 20) via a mobile communication network or the like.

Various aspects of the subject matter described herein may be set out non-exhaustively in the following numbered clauses:

1. An information processing apparatus including:

a hardware processor configured to execute a process related to providing a user with an incentive, when data related to a work machine with a work attachment and satisfying a predetermined condition are obtained according to an input of the user to a predetermined input device.

2. An information processing method executed by a computer, including:

executing a process related to providing a user with an incentive, when data related to a work machine with a work attachment and satisfying a predetermined condition are obtained according to an input of the user to a predetermined input device.

3. A work machine including:

a work attachment; and

a hardware processor configured to
receive, from an outside, a request to obtain operating data satisfying a predetermined condition, the request offering an incentive for a user;
receive an input from the user; and
obtain the operating data satisfying the predetermined condition according to the received input.

What is claimed is:

1. A data collection system comprising:
an input device configured to receive an input from a user;
a first hardware processor configured to obtain data related to a work machine with a work attachment and satisfying a predetermined condition, according to the input received by the input device; and
a second hardware processor configured to execute a process related to providing the user with an incentive when the first hardware processor obtains the data.

2. The data collection system as claimed in claim 1, wherein
the first hardware processor or the second hardware processor is further configured to provide original data related to the industrial machine,
the first hardware processor is further configured to notify the user of contents of the original data, and
the first hardware processor is further configured to obtain the data based on the original data, according to the input with respect to the original data received by the input device.

3. The data collection system as claimed in claim 2, wherein the first hardware processor is further configured to obtain the data, the data being a combination of the original data and metadata satisfying the predetermined condition with respect to the original data, the metadata being generated according to the input with respect to the original data received by the input device.

4. The data collection system as claimed in claim 3, wherein the metadata are data representing ground truth for supervised learning.

5. The data collection system as claimed in claim 3, wherein
the original data are data on at least one of a condition of the work machine, a condition of a surrounding environment of the work machine, and a condition of an operator of the work machine, during an operation of the work machine, and
the metadata are data related to an attribute of the operator of the work machine.

6. The data collection system as claimed in claim 2, wherein the first hardware processor is further configured to selectively obtain the data satisfying the predetermined condition from among multiple items of the original data, according to a selection input with respect to the multiple items of the original data received by the input device.

7. The data collection system as claimed in claim 2, wherein the first hardware processor is further configured to obtain the data in which processing satisfying the predetermined condition is performed on the original data, according to the input with respect to the original data received by the input device.

8. The data collection system as claimed in claim 1, wherein the first hardware processor is further configured to newly obtain the data according to the input received by the input device.

9. The data collection system as claimed in claim 1, wherein
the second hardware processor is further configured to determine whether the data obtained by the first hardware processor satisfy the predetermined condition, and
the second hardware processor is further configured to execute the process related to providing the user with the incentive, in response to determining that the data obtained by the first hardware processor satisfy the predetermined condition.

10. The data collection system as claimed in claim 9, further comprising:
a third hardware processor configured to notify another user of contents of the data obtained by the first hardware processor; and
another input device configured to receive an input from said another user,
wherein the second hardware processor is further configured to determine whether the data obtained by the first hardware processor satisfy the predetermined condition, according to the input received by said another input device with respect to a check result as to whether the data obtained by the first hardware processor satisfy the predetermined condition.

11. The data collection system as claimed in claim 10, wherein the second hardware processor is further configured to execute a process related to providing said another user with the incentive when said another input device receives the input with respect to the check result.

12. The data collection system as claimed in claim 9, wherein the second hardware processor is configured to determine whether the data obtained by the first hardware processor satisfy the predetermined condition by inputting the data obtained by the first hardware processor to a predetermined trained model.

13. A non-transitory computer-readable recording medium storing a program that causes a computer to execute a process related to providing a user with an incentive, when data related to a work machine with a work attachment and satisfying a predetermined condition are obtained according to an input of the user to a predetermined input device.

14. A non-transitory computer-readable recording medium storing a program that causes a computer to execute a process, the process comprising:
receiving, from an outside, a request to obtain data related to a work machine with a work attachment and satisfying a predetermined condition, the request offering an incentive for a user;
receiving an input from the user; and
obtaining the data satisfying the predetermined condition according to the received input.
